(19) United States
(12) Patent Application Publication
(10) Pub. No.: US 2020/0229155 A1
(43) Pub. Date: Jul. 16, 2020

(54) BASE STATION FOR MOBILE COMMUNICATION SYSTEM

(71) Applicant: Institute For Information Industry, Taipei (TW)

(72) Inventors: Chun-Che CHIEN, Taipei (TW); Hai-Han WANG, Taipei (TW)

(21) Appl. No.: 16/695,175

(22) Filed: Nov. 25, 2019

Related U.S. Application Data
(60) Provisional application No. 62/791,033, filed on Jan. 11, 2019.

(51) Int. Cl. H04W 72/04; H04W 72/10

(52) U.S. Cl. CPC H04W 72/042; H04W 72/048; H04W 72/10; H04W 72/044

(57) ABSTRACT

A base station (BS) for a mobile communication system is provided. The BS generates resource configuration setting information according to periodic traffic pattern information associated with a user equipment (UE). The resource configuration setting information includes a plurality of resource configurations. The BS transmits the resource configuration setting information to the UE. Afterwards, the BS transmits first downlink control information (DCI) to the UE. The DCI indicates that at least one of the resource configurations is activated.

### PRIORITY

This application claims priority to U.S. Provisional Patent Application No. 62/791,033 filed on Jan. 11, 2019, which is hereby incorporated by reference in its entirety.

### FIELD

The present invention relates to a base station for a mobile communication system. Specifically, the base station generates resource configuration setting information according to periodic traffic pattern information associated with a user equipment and provides the resource configuration setting information to the user equipment for the user equipment to perform periodic signal transmission.

### BACKGROUND

With the rapid development of wireless communication technologies, various applications of wireless communication have become ubiquitous in people's life, and demands of people for wireless communication are also increasing day by day. In order to satisfy various applications in life, the next generation of mobile communication system (which is commonly called the 5G mobile communication system currently) proposes new service modes, e.g., Ultra-reliable and Low Latency communication (URLLC), Enhanced Mobile Broadband (eMBB) communication, Massive Machine Type Communications (mMTC). In these service modes, the URLLC service mode is to meet the transmission requirements of low latency and reliability, so the URLLC service is quite suitable for vehicle communication or industrial communication.

Traditional industrial communication adopts a time sensitive networking (TSN) communication standard, the signal transmission of which is based on Ethernet. The current academics and industries have been interested in if the TSN system is able to be integrated into a 5G mobile communication system (i.e., 5G time sensitive communication (TSC)) so that communication among devices of the TSN system can be achieved through the 5G mobile communication system, especially the communication between a central control device of the TSN system and the manipulating industrial devices distributed to various places. However, the TSN system and the 5G mobile communication system belong to wired and wireless communication respectively, and have substantial differences in use condition and network protocol. Therefore, if the TSN system is to be integrated into the 5G mobile communication system, then the 5G mobile communication system must meet the reliability and latency stipulated and required by the TSN system, especially the periodic transmission requirements of the TSN system.

Accordingly, an urgent need exists in the art to provide a resource configuration mechanism to integrate the TSN system into the 5G mobile communication system while meeting the reliability and latency stipulated and required by the TSN system.

### SUMMARY

Provided is a resource configuration mechanism. Under this resource configuration mechanism, a base station of the 5G mobile communication system may provide resource configuration setting information to a user equipment according to periodic traffic pattern information associated with the user equipment for the user equipment to perform periodic signal transmission. Accordingly, the resource configuration mechanism can integrate the TSN system into the 5G mobile communication system and meets the reliability and latency stipulated and required by the TSN system. In addition, the resource configuration mechanism can also be used for periodic transmission of the URLLC service type and the eMBB service type.

Provided is a base station, which comprises a storage, a transceiver and a processor. The storage is configured to store periodic traffic pattern information associated with a user equipment. The processor is electrically connected to the transceiver and the storage, and is configured to perform the following operations: generating resource configuration setting information according to the periodic traffic pattern information, the resource configuration setting information comprising a plurality of resource configurations, a first resource configuration of the resource configurations comprising a first period length, a first period offset and a first resource assignment; transmitting the resource configuration setting information to the user equipment via the transceiver; and transmitting first downlink control information to the user equipment via the transceiver, the first downlink control information indicating that at least one of the resource configurations is activated.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 depicts a schematic view of signal transmission between a base station 1 and a user equipment 2 according to the present invention;

FIG. 2 depicts an implementation scenario of a first resource configuration according to the present invention;

FIG. 3 depicts an implementation scenario of the first resource configuration according to the present invention;

FIG. 4 depicts an implementation scenario of the first resource configuration according to the present invention;

FIG. 5A depicts an implementation scenario of the first resource configuration according to the present invention;

FIG. 5B depicts an implementation scenario of the first resource configuration according to the present invention;

FIG. 6 depicts a schematic view of signal transmission between the base station 1 and the user equipment 2 according to the present invention;

FIG. 7 depicts a schematic view of signal transmission between the base station 1 and the user equipment 2 according to the present invention;

FIG. 8 depicts a schematic view of a correspondence relationship between a bit state of downlink control information and the resource configurations according to the present invention;

FIG. 9 depicts an implementation scenario of the first resource configuration and a second resource configuration according to the present invention;

FIG. 10 depicts an implementation scenario of the first resource configuration and the second resource configuration according to the present invention;

FIG. 11 depicts an implementation scenario of the first resource configuration and the second resource configuration according to the present invention;

FIG. 12 depicts an implementation scenario of the first resource configuration and the second resource configuration according to the present invention;

FIG. 13 depicts an implementation scenario of the first resource configuration and the second resource configuration according to the present invention;

FIG. 14 depicts a schematic view of signal transmission between the base station 1 and the user equipment 2 according to the present invention;

FIG. 15 depicts an implementation scenario of the first resource configuration, the second resource configuration and a third resource configuration according to the present invention; and

FIG. 16 depicts a schematic view of the base station 1 according to the present invention.

### DETAILED DESCRIPTION

In the following description, the present invention will be explained with reference to certain example embodiments thereof. These example embodiments are not intended to limit the present invention to any specific environment, example, embodiment, applications or particular implementations described in these example embodiments. Therefore, description of these example embodiments is only for purpose of illustration rather than to limit the present invention.

It shall be appreciated that, in the following embodiments and the attached drawings, elements unrelated to the present invention are omitted from depiction; and dimensional proportions among individual elements in the attached drawings are provided only for ease of understanding, but not to limit the actual scale of the present invention.

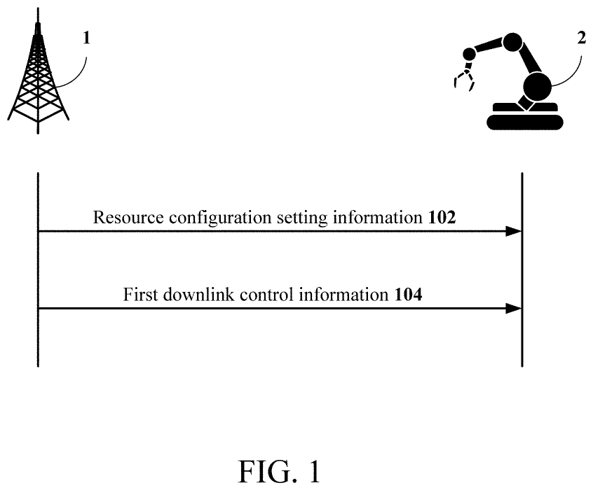

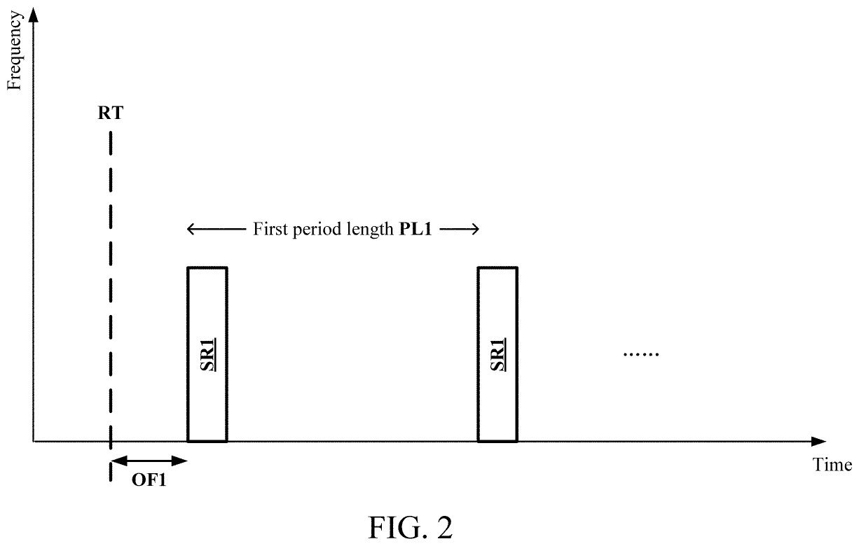

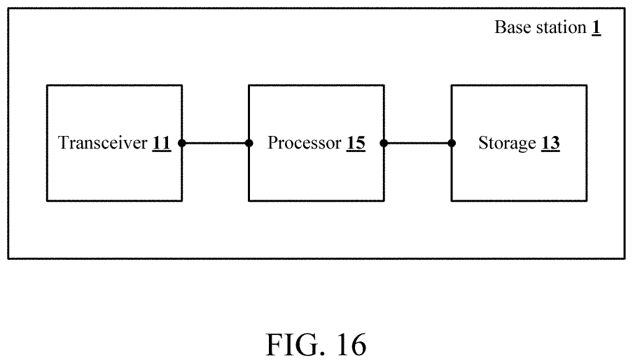

A first embodiment of the present invention is as shown in FIG. 1 and FIG. 2. In this embodiment, for simplification of description, only the resource configuration between a base station 1 and a single user equipment (UE) 2 is illustrated to describe how the base station 1 provides resource configuration setting information to the user equipment 2 according to periodic traffic pattern information associated with the user equipment 2 for the user equipment 2 to perform periodic signal transmission. Components of the base station 1 and functions of these elements will be further described in an embodiment corresponding to FIG. 16. As shall be appreciated by those of ordinary skill in the art based on the following description, the base station 1 may also perform signal transmission with other user equipments simultaneously and perform same transmission operations with other user equipments, and this will not be further described herein.

The base station 1 is adapted for use in a mobile communication system, which may be a next generation of mobile communication system (which is broadly referred to as a 5G mobile communication system currently) or any mobile communication system based on the Orthogonal Frequency Division Multiple Access (OFDMA) technology. The following description takes the 5G mobile communication system as an example for illustration. However, how to apply the technical means of the present invention to other mobile communication systems based on the OFDMA technology shall be appreciated by those of ordinary skill in the art, and thus will not be further described herein. In this embodiment, the user equipment 2 may be an equipment in a time sensitive networking (TSN) system, such as a robot arm or an industrial control machine or the like. However, in other embodiments, the user equipment 2 may be a device of the URLLC service type or the eMBB service type (e.g., an autonomous vehicle).

The base station 1 stores periodic traffic pattern information associated with the user equipment 2, such as at least one of an uplink signal arrival time, a downlink signal arrival time, a period, a packet size, and a transport block size (TBS) (but not limited thereto). The periodic traffic pattern information may be transmitted by the server of the TSN system to the base station 1 through the core network of the 5G mobile communication system, or reported to the base station 1 by the user equipment 2 itself. In addition, when the user equipment 2 is handed over from another base station to the base station 1, the base station 1 may receive the periodic traffic pattern information of the user equipment 2 from the another base station.

Referring to FIG. 1, the base station 1 generates resource configuration setting information 102 according to the periodic traffic pattern information associated with the user equipment 2, and transmits the resource configuration setting information 102 to the user equipment 2. The base station 1 further transmits first downlink control information (DCI) 104 to the user equipment 2 so that the user equipment 2 activates at least one of the resource configurations according to the first downlink control information 104. The resource configuration setting information 102 includes a plurality of resource configurations. Each resource configuration is used for periodic uplink transmission, periodic downlink transmission or periodic side link transmission.

For example, as shown in FIG. 2, the first resource configuration of the resource configurations includes a first period length PL1, a first period offset OF1 and a first resource assignment. The first period length PL1 is determined by information provided by the TSN system. The first period offset OF1 is with respect to a time reference point RT and takes one of a frame length, a slot length and a symbol length as a unit. The time reference point RT is one of a frame boundary, a slot boundary and a symbol boundary. In other words, the time reference point RT may be a certain frame boundary, a certain slot boundary in a certain frame, or a certain symbol boundary of a certain slot in a certain frame.

The first resource assignment describes at least one resource SR1 in a first period interval, a frequency position of each of the at least one resource SR1, and a start and length indicator value (SLIV) of each of the at least one resource SR1. The start value of each SLIV is represented by an offset in the time domain. The offset is with respect to one of a slot boundary and a start symbol boundary of a physical downlink control channel (PDCCH) resource.

In an embodiment, the offset may also be with respect to an end symbol boundary of a physical downlink control channel (PDCCH) resource. In addition, the base station 1 may inform the user equipment 2 of the reference of the offset through a radio resource control (RRC) message.

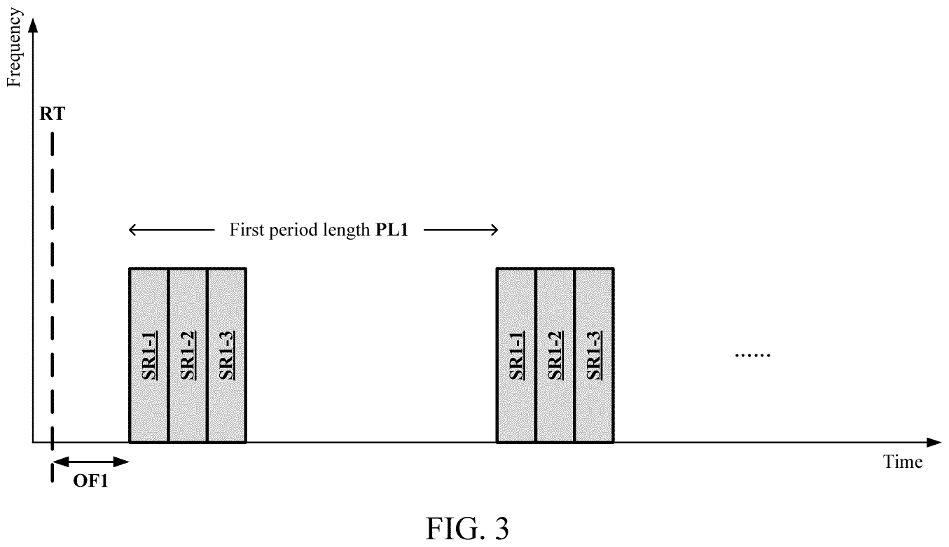

In an embodiment, the base station 1 may allocate a plurality of continuous retransmission resources in a first period interval. For example, as shown in FIG. 3, the first resource assignment describes a plurality of retransmission resources SR1-1 to SR1-3 in the first period interval, and the time domain position of each of the retransmission resources SR1-1 to SR1-3 is determined by a start and length indicator value (SLIV) of the first retransmission resource SR1-1 of the retransmission resources SR1-1 to SR1-3 and a number of repetitions of the retransmission resources SR1-1 to SR1-3.

In an embodiment, the resource assignment of each resource configuration in the resource configuration setting information 102 may be carried in a radio resource control (RRC) message or downlink control information (DCI) and transmitted to the user equipment 2, while the period offset and the period length for each resource configuration may be included in the RRC message and transmitted to the user equipment 2. The base station 1 may describe the start and length indicator value (SLIV) and the number of repetitions through the radio resource control (RRC) message or the downlink control information. The downlink control information may dynamically adjust settings indicated by the previous downlink control information or overwrite settings indicated by the RRC message.

Furthermore, the first resource assignment may have an index. Specifically, the base station 1 may define a mapping table and transmit the mapping table to the user equipment 2 in advance through higher layer signaling, e.g., through the RRC message. The mapping table describes the start and length indicator value (SLIV) and the time of repetitions corresponding to each index. Therefore, according to the index included in the first resource assignment, the user equipment 2 may query the mapping table to obtain the SLIV and the number of repetitions corresponding to the index.

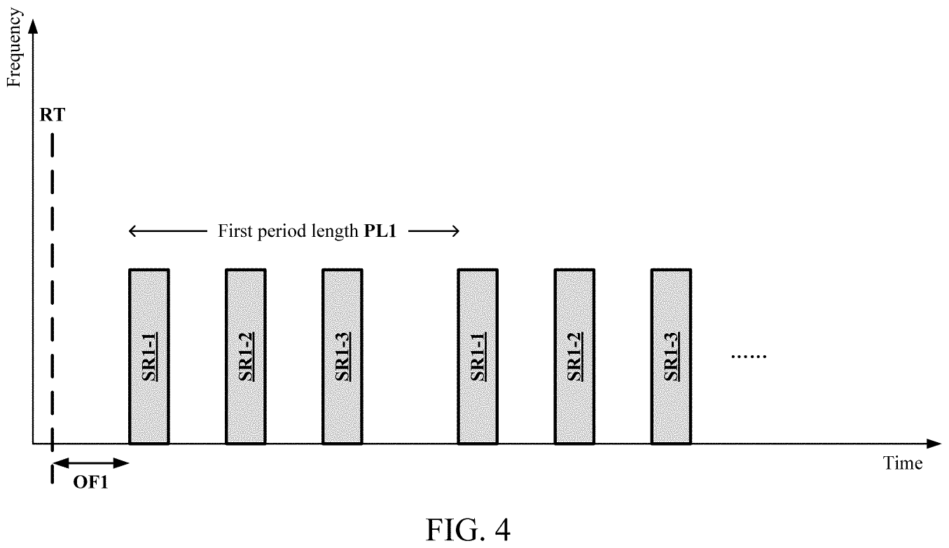

In other embodiments, as shown in FIG. 4, the retransmission resources SR1-1 to SR1-3 allocated by the base station 1 in the first period interval may also be discontinuous.

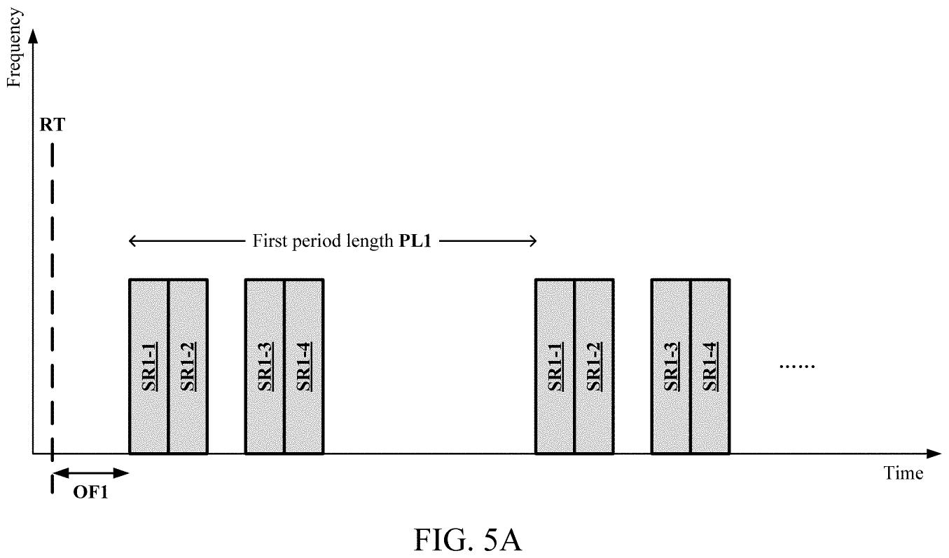

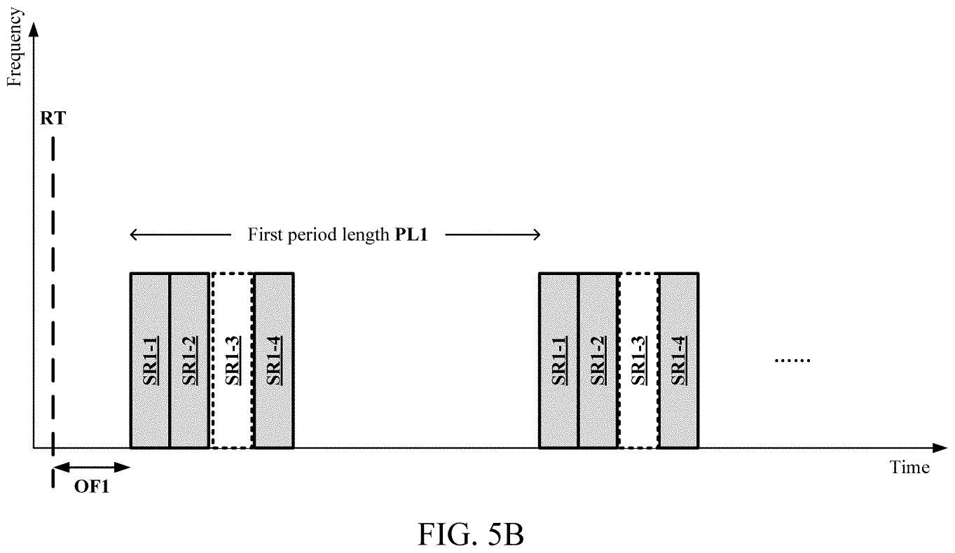

In other embodiments, as shown in FIG. 5A, four retransmission resources SR1-1 to SR1-4 allocated by the base station 1 in the first period interval may have both continuous and discontinuous retransmission resources. In the implementation scenario shown in FIG. 5A, the base station 1 may wish to allocate a plurality of continuous uplink retransmission resources in the first period interval. However, since there may be resources (e.g., downlink resources) that must be used for other transmissions in the first period interval, the base station 1 must allocate the retransmission resources SR1-1 to SR1-4 while avoiding these resources for other transmissions.

In other embodiments, as shown in FIG. 5B, the base station 1 allocates four continuous uplink retransmission resources SR1-1 to SR1-4 in the first period interval. However, since the interval within the uplink retransmission resource SR1-3 in the first period interval exists a resource (e.g., a downlink resource) that must be used for other transmissions, the user equipment 2 does not use the uplink retransmission resource SR1-3 for uplink transmission.

In an embodiment, the first resource assignment describes a modulation and coding scheme (MCS) table, and the MCS table corresponds to a traffic type. Therefore, as the traffic type corresponding to each resource configuration varies, the MCS table described by the resource configuration may also vary. The traffic type may be a robot arm, an augmented reality (AR) or a virtual reality (VR), but not limited thereto. The period length of different traffic types may also be different.

In an embodiment, the first resource configuration further includes the traffic type information of the first resource configuration. In other words, each resource configuration may include information directly describing the traffic type thereof. The traffic type information may include a priority level of the traffic type. In other embodiments, the first resource configuration has a first identifier, and the first identifier corresponds to a traffic type.

The resource configuration setting information 102 may include at least one logical channel identifier corresponding to the first resource configuration, and each of the at least one logical channel identifier corresponds to a priority level that is associated with a traffic type. The resource configuration setting information 102 generated by the base station 1 may include at least one logical channel identifier corresponding to the first resource configuration and the first identifier in the first resource configuration at the same time.

Regarding the information of the above-mentioned various identifiers, the base station 1 may inform the user equipment 2 through the resource configuration setting information 102 or inform the user equipment 2 in advance through the higher layer signaling, e.g., through the RRC message. In addition, the resources of the base station 1 may be reconfigured as needed to generate new configuration setting information 102 and transmit the new configuration setting information 102 to the user equipment 2.

In addition, the base station 1 may further receive a user equipment capability report message from the user equipment 2 and generate the resource configuration setting information 102 according to both the user equipment capability report message and the periodic traffic pattern information. The user equipment capability report message comprises the actual operation pattern and the computing capability of the user equipment 2. The base station 1 may determine how many resource configurations will be allocated for use by the user equipment 2 (i.e., the number of resource configurations) and the number of resource configurations that may be activated simultaneously among the resource configurations according to the user equipment capability report message.

According to the above description, the resource configuration mechanism of the present invention may be used for periodic transmission of the TSN system type, the URLLC service type and the eMBB service type. In other words, different resource configurations may have different period lengths to meet different periodic traffic patterns.

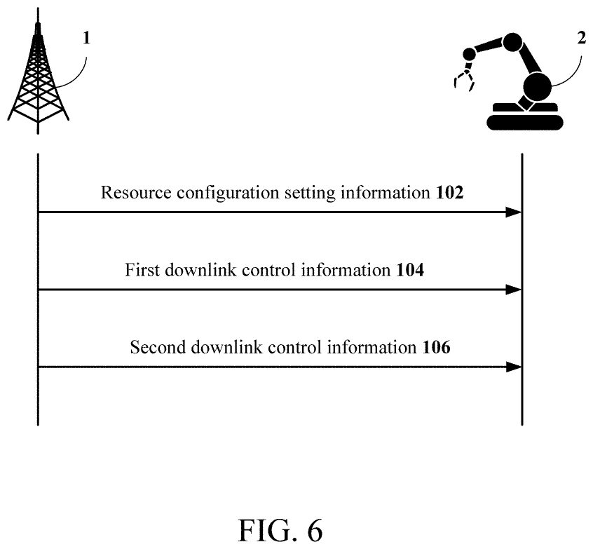

A second embodiment of the present invention is as shown in FIG. 6 to FIG. 8. The second embodiment is an extension of the first embodiment. The base station 1 further transmits second downlink control information 106 to the user equipment 2, and the second downlink control information 106 instructs the user equipment 2 to release a part or all of the at least one of the activated resource configurations. It shall be noted that, the resource configuration is released for on the side of the user equipment 2, while the resource configuration is deactivated on the side of the base station 1.

For example, it is assumed that the base station 1 has previously instructed the user equipment 2 to activate three resource configurations among these resource configurations, and when the base station 1 determines that the user equipment 2 does not need to use the three resource configurations at present, the base station 1 may transmit the second downlink control information 106 to instruct the user equipment 2 to release the activated three resource configurations or only release a part (i.e., one or two) of the resource configurations. As another example, when the base station 1 determines that resources of the resource configuration that currently may be allocated to other user equipments are insufficient and other user equipments have a higher priority than the user equipment 2, the base station 1 will also transmit the second downlink control information 106 to request the user equipment 2 to release a part of the resource configurations.

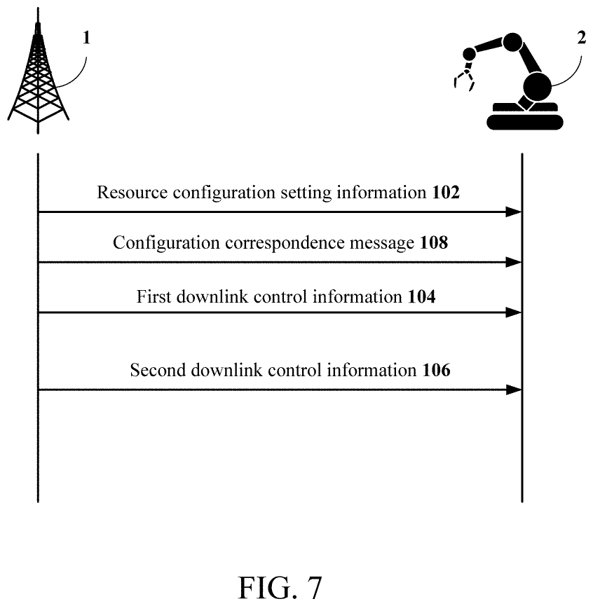

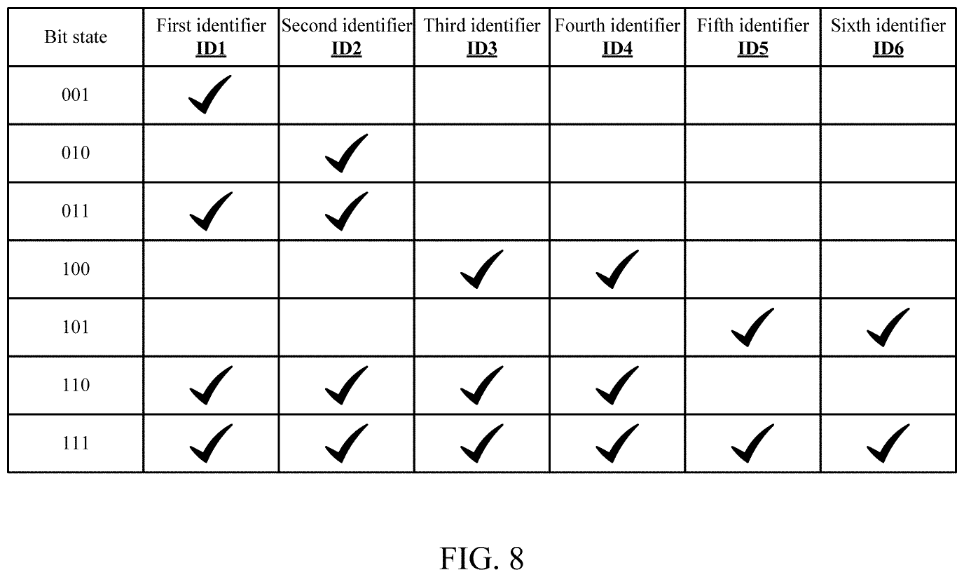

Please further refer to FIG. 7. Each resource configuration may have an identifier. The base station 1 may transmit a configuration correspondence message 108 to the user equipment 2, and the configuration correspondence message 108 describes a first correspondence relationship between a bit state of the first downlink control information 104 and the resource configurations, and a second correspondence relationship between a bit state of the second downlink control information 106 and the resource configurations. For example, referring to FIG. 8, it is assumed that the first resource configuration has a first identifier ID1, the second resource configuration has a second identifier ID2, the third resource configuration has a third identifier ID3, the fourth resource configuration has a fourth identifier ID4, the fifth resource configuration has a fifth identifier ID5, and the sixth resource configuration has a sixth identifier ID6. If the bit state of the second downlink control information 106 is 001, then the user equipment 2 will only release the first resource configuration corresponding to the first identifier ID1 after receiving the first downlink control information 106.

If the bit state of the second downlink control information 106 is 010, then the user equipment 2 will only release the second resource configuration corresponding to the second identifier ID2 after receiving the second downlink control information 106. If the bit state of the second downlink control information 106 is 011, then the user equipment 2 will release the first resource configuration corresponding to the first identifier ID1 and the second resource configuration corresponding to the second identifier ID2 after receiving the second downlink control information 106. If the bit state of the second downlink control information 106 is 100, then the user equipment 2 will release the third resource configuration corresponding to the third identifier ID3 and the fourth resource configuration corresponding to the fourth identifier ID4 after receiving the second downlink control information 106. If the bit state of the second downlink control information 106 is 101, then the user equipment 2 will release the fifth resource configuration corresponding to the fifth identifier ID5 and the sixth resource configuration corresponding to the sixth identifier ID6 after receiving the second downlink control information 106.

If the bit state of the second downlink control information 106 is 110, then the user equipment 2 will release the first resource configuration corresponding to the first identifier ID1, the second resource configuration corresponding to the second identifier ID2, the third resource configuration corresponding to the third identifier ID3, and the fourth resource configuration corresponding to the fourth identifier ID4 after receiving the second downlink control information 106. If the bit state of the second downlink control information 106 is 111, then the user equipment 2 will release all the resource configurations after receiving the second downlink control information 106.

The example of FIG. 8 illustrates a second correspondence relationship between the bit state of the second downlink control information 106 and the resource configurations. Those of ordinary skill in the art shall appreciate that the first correspondence relationship between the bit state of the first downlink control information 104 and the resource configurations may also be the same as or different from the second correspondence relationship, and various possible designs of the first correspondence relationship shall also be appreciated by those of ordinary skill in the art. Furthermore, the base station 1 may inform the user equipment 2 of the correspondence relationships in advance through higher layer signaling, e.g., through an RRC message. Accordingly, the present invention may achieve the purpose of individually or simultaneously activating and releasing resource configurations by designing the first correspondence relationship between the bit state of the first downlink control information 104 and the resource configurations as well as the second correspondence relationship between the bit state of the second downlink control information 106 and the resource configurations.

In addition, the above example is illustrated with a case where a bit length of a field used to describe the activating or releasing of the resource configurations in the downlink control information is 3 bits. However, depending on the practice, the bit length of this field may be designed differently (e.g., to be 4 bits). How to design the correspondence relationship between the bit state of the field and the resource configurations according to the bit length of the field shall be appreciated by those of ordinary skill in the art based on the above description, and thus will not be further described herein.

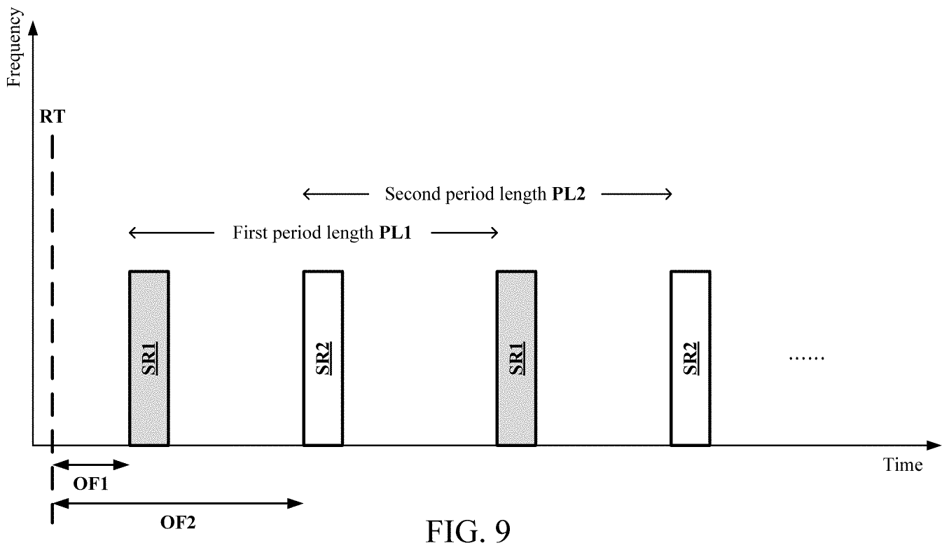

A third embodiment of the present invention is as shown in FIG. 9 to FIG. 13, which depict different implementation scenarios of allocating resources by the base station 1. The third embodiment is an extension of the first embodiment and the second embodiment. As shown in FIG. 9, the second resource configuration of the resource configurations includes a second period offset OF2, a second period length PL2 and a second resource assignment. Similarly, the second period length PL2 is determined by the information provided by the TSN system. The second period offset OF2 is with respect to a time reference point RT and takes one of a frame length, a slot length and a symbol length as a unit.

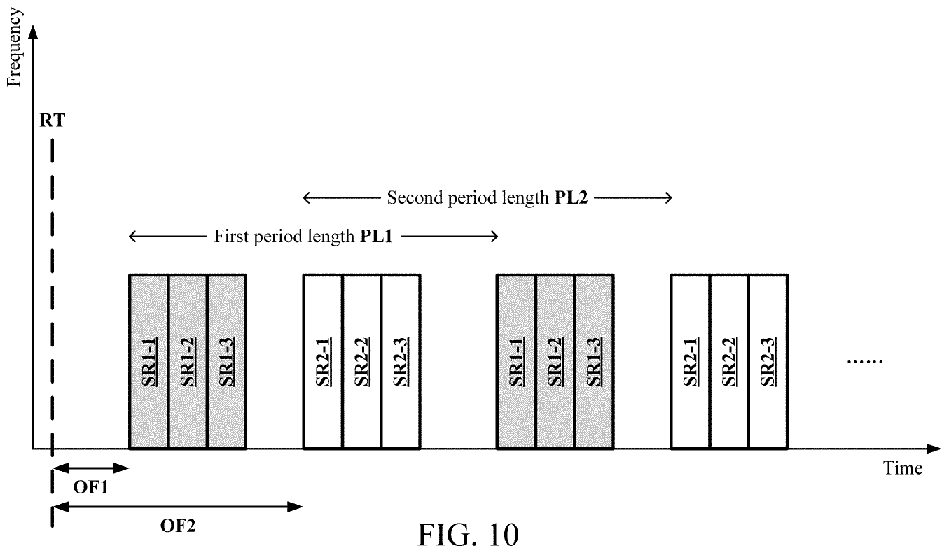

The second resource assignment describes at least one resource SR2 in a second period interval, a frequency position of each of the at least one resource SR2, and a start and length indicator value (SLIV) of each of the at least one resource SR2. The start value of each SLIV is represented by an offset in the time domain. Moreover, similar to the first embodiment, the base station 1 may also continuously or discontinuously allocate retransmission resources SR2-1 to SR2-3 in the second period interval or simultaneously allocate the retransmission resources SR2-1 to SR2-3 in the second period interval in a continuous and discontinuous manner, as shown in FIG. 10 to FIG. 13.

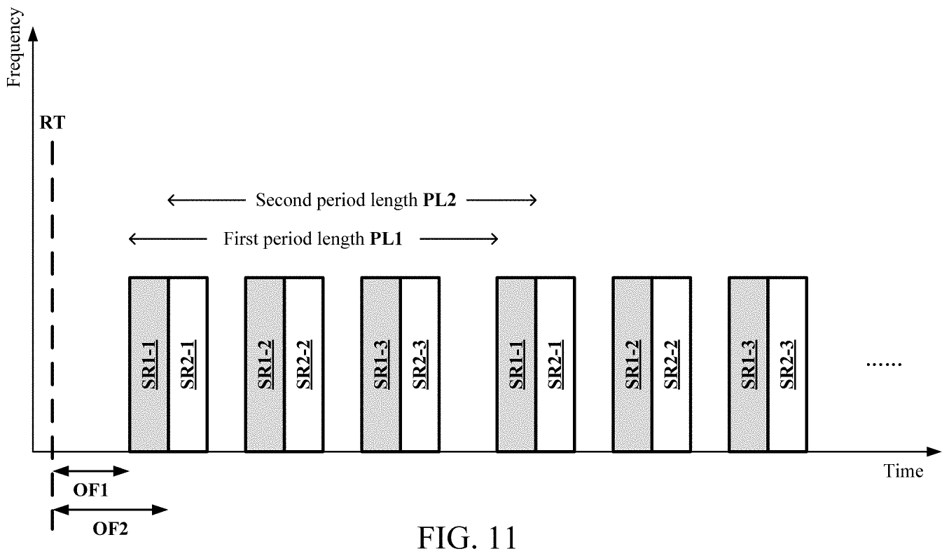

FIG. 10 depicts that both the retransmission resources SR1-1 to SR1-3 of the first resource assignment and the retransmission resources SR2-1 to SR2-3 of the second resource assignment are continuous resources in the period intervals to which they belong. FIG. 11 depicts that both the retransmission resources SR1-1 to SR1-3 of the first resource assignment and the retransmission resources SR2-1 to SR2-3 of the second resource assignment are discontinuous resources in the period intervals to which they belong, and the resources of the first resource assignment and the second resource assignment are interleaved and adjacent.

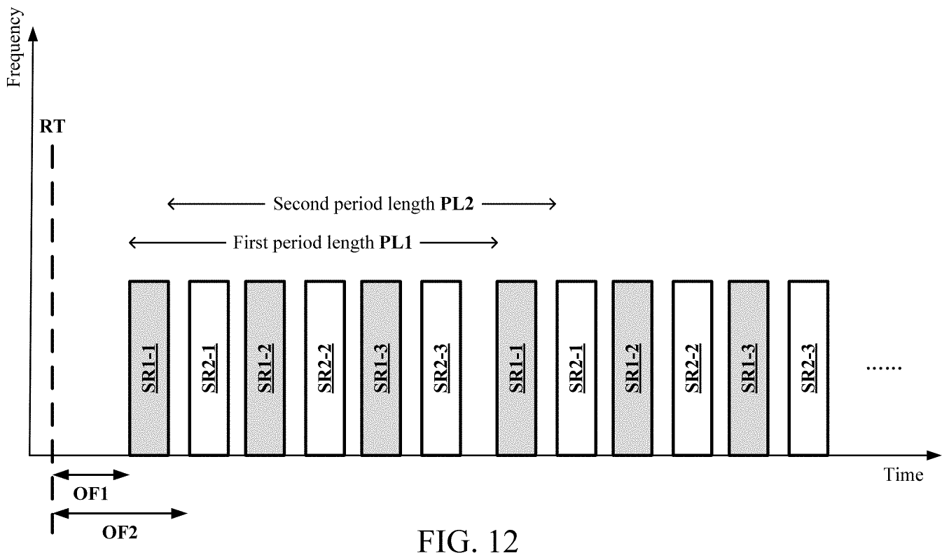

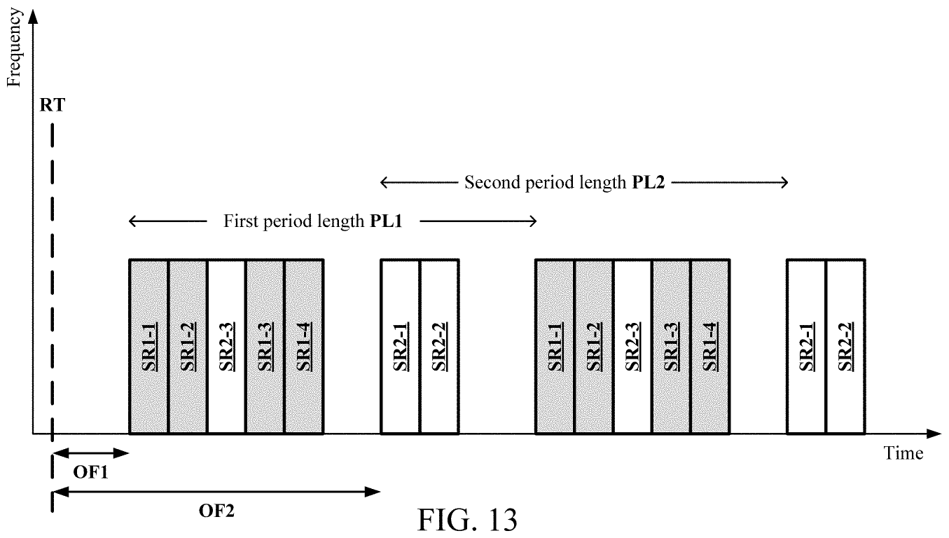

FIG. 12 depicts that both the retransmission resources SR1-1 to SR1-3 of the first resource assignment and the retransmission resources SR2-1 to SR2-3 of the second resource assignment are discontinuous resources in the period intervals to which they belong, and the resources of the first resource assignment and the second resource assignment are interleaved and not adjacent. FIG. 13 depicts that both the retransmission resources SR1-1 to SR1-3 of the first resource assignment and the retransmission resources SR2-1 to SR2-3 of the second resource assignment are partially continuous and partially discontinuous resources in the period intervals to which they belong.

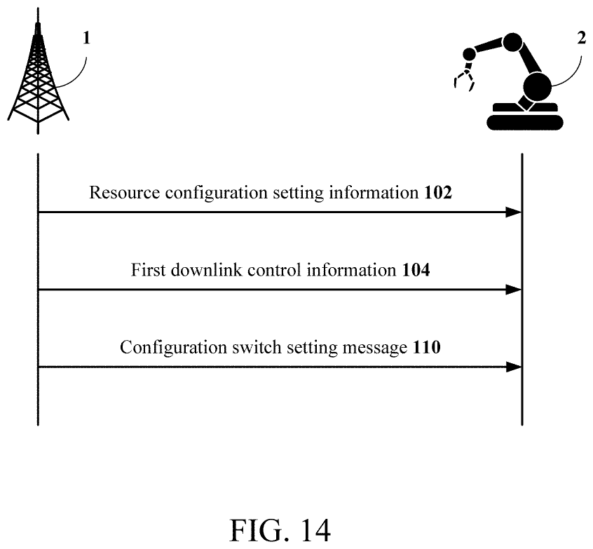

In an embodiment, as shown in FIG. 14, the base station 1 may transmit a configuration switch setting message 110 to the user equipment 2 so that the user equipment 2 may alternately use the first resource configuration and the second resource configuration according to the configuration switch setting message 110. For example, if the transmission period required by the user equipment 2 is not an integer multiple of an OFDM symbol, then in this case, the base station 1 may configure the first period length PL1 of the first resource configuration and the second period length PL2 of the second resource configuration such that an average period length of the first period length PL1 and the second period length PL2 may conform to the transmission period required by the user equipment 2.

In an embodiment, the configuration switch setting message 110 further indicates at least one time length of at least one timer so that the user equipment 2 alternately uses the first resource configuration and the second resource configuration according to the at least one timer. The time length of each of the at least one timer may be different, and each timer may correspond to at least one activated resource configuration. In other words, switching among the multiple resource configurations of the present invention may be achieved through the same or different timers.

In an embodiment, the first resource configuration is used for periodic downlink transmission and has a first identifier ID1, the second resource configuration is used for periodic uplink transmission and has a second identifier ID2, and the first identifier ID1 is associated with the second identifier ID2 for simultaneously activating or releasing the first resource configuration and the second resource configuration. Regarding the association information between the first identifier ID1 and the second identifier ID2, the base station 1 may inform the user equipment 2 in advance through higher layer signaling, e.g., through an RRC message.

It shall be noted that in this embodiment, two resource configurations are taken as an example for illustration. Various implementation scenarios of more than three resource configurations shall be appreciated by those of ordinary skill in the art based on the above explanation (e.g., the base station 1 may instruct the user equipment 2 to alternately use more than three activated resource configurations through the configuration switch setting message 110), and thus will not be further described herein.

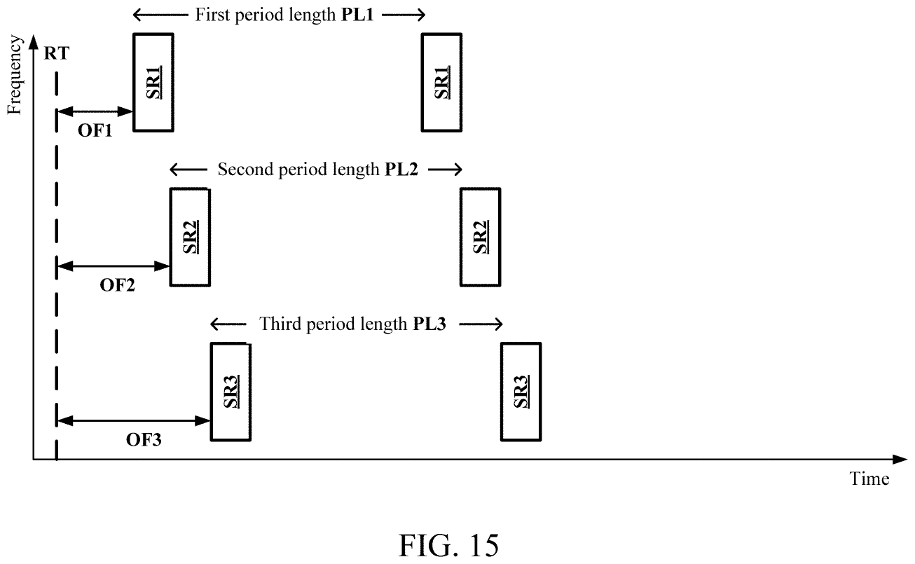

In addition, the above-mentioned resource configurations are illustrated with the case of allocating resources on the same frequency band. However, in other embodiments, the resources of the resource configurations may have different frequency band positions from each other. For example, FIG. 15 depicts that the resource SR1 of the first resource configuration, the resource SR2 of the second resource configuration and the resource SR3 of the third resource configuration are located on different frequency bands from each other. Similarly, the third resource configuration includes a third period offset OF3, a third period length PL3 and a third resource assignment. The third resource assignment describes at least one resource SR3 in a third period interval, a frequency position of each of the at least one resource SR3, and a start and length indicator value (SLIV) of each of the at least one resource SR3. The start value of each SLIV is represented by an offset in the time domain. Moreover, the resources SR1 of the first resource configuration, the resources SR2 of the second resource configuration and the resources SR3 of the third resource configuration may be overlapped with each other in the time domain. Thus, when these resources belong to uplink resources, the user equipment 2 may select resources that meet its latency requirements for uplink transmission according to actual transmission requirements thereof.

In an embodiment, if the user equipment 2 needs to perform uplink transmission of two traffic types at the same time and the resources of these resource configurations are partially overlapped in the time domain, the resource configuration corresponding to the highest priority level may be selected according to the priority level of the traffic type for uplink transmission.

In addition, the resource configuration setting information 102 may also include a bandwidth part (BWP) identifier corresponding to the first resource configuration. For example, the resource SR1 of the first resource configuration, the resource SR2 of the second resource configuration and the resource SR3 of the third resource configuration shown in FIG. 15 may be located at different bandwidth parts from each other.

Please refer to FIG. 9 to FIG. 15 again for a fourth embodiment of the present invention. In this embodiment, the resource configuration setting information 102 includes a group identifier and group information. The group information describes that a part of the resource configurations belongs to a same group, and the resource configurations in the same group have at least one same resource configuration setting value.

For example, in the implementation scenarios of FIG. 9 to FIG. 13, the base station 1 may divide the first resource configuration and the second resource configuration into a same group. The only difference between the first resource configuration and the second resource configuration is that the period offsets are different (i.e., the first period offset OF1 and the second period offset OF2 are different), while the remaining resource configuration setting values are the same. In this case, the resource configuration setting information 102 only needs to describe the first resource configuration in detail, and for the second resource configuration, the resource configuration setting information 102 only needs to describe that the second resource configuration belongs to the same group as the first resource configuration and describe the difference between the second resource configuration and the first resource configuration (i.e., the second period offset OF2).

As another example, in the implementation scenario of FIG. 15, the base station 1 may divide the first resource configuration, the second resource configuration and the third resource configuration into a same group. The difference among the first resource configuration, the second resource configuration and the third resource configuration is that the period offsets are different (i.e., the first period offset OF1, the second period offset OF2 and the third period offset OF3 are different from each other) and the frequency bands in which the resources are located are different, while the remaining resource configuration setting values are the same.

It shall be noted that, the above-mentioned number of resource configurations and resource configuration setting values are only taken as examples. The base station 1 may describe more than three resource configurations as the same group, and in the same group, there may be a plurality of different resource configuration setting values. How the base station 1 describes a plurality of resource configurations belonging to the same group through the resource configuration setting information 102 shall be appreciated by those of ordinary skill in the art based on the above description, and thus will not be further described herein.

In an embodiment, the resource assignment of each resource configuration in the resource configuration setting information 102 may be carried in the DCI and transmitted to the user equipment 2, while the period offset and the period length for each resource configuration may be comprised in the RRC message and transmitted to the user equipment 2. In an embodiment, the resource configuration setting information 102 may be all included in the RRC message and transmitted to the user equipment 2.

A fifth embodiment of the present invention is as shown in FIG. 16, which is a schematic view of the base station 1 of the present invention. The base station 1 comprises a transceiver 11, a storage 13 and a processor 15. The processor 15 is electrically connected to the transceiver 11 and the storage 13. The storage 13 stores periodic traffic pattern information associated with a user equipment. The processor 15 may be one of various processors, central processing units (CPUs), microprocessors, digital signal processors, or other computing devices known to those of ordinary skill in the art. For simplifying the description, other components of the base station 1, such as a housing, a power supply module and other components that are less relevant to the present invention, are omitted from depiction in the drawings.

Corresponding to the first embodiment, the processor 15 generates resource configuration setting information according to the periodic traffic pattern information. The resource configuration setting information comprises a plurality of resource configurations. Each resource configuration may be used for periodic uplink transmission, periodic downlink transmission or periodic side link transmission. A first resource configuration of the resource configurations comprises a first period length, a first period offset and a first resource assignment. The processor 15 transmits the resource configuration setting information to the user equipment and transmits first downlink control information to the user equipment via the transceiver 11. The first downlink control information indicates that at least one of the resource configurations is activated.

The first resource assignment may describe at least one resource in a first period interval, a frequency position of each of the at least one resource, and a start and length indicator value (SLIV) of each of the at least one resource, and a start value of the SILO of each of the at least one resource is represented by an offset in the time domain.

In an embodiment, the offset is with respect to one of a slot boundary and a start symbol boundary of a physical downlink control channel (PDCCH) resource.

In an embodiment, the first period offset is with respect to a time reference point. The time reference point may be one of a frame boundary, a slot boundary and a symbol boundary, and a unit of the first period offset may be one of a frame length, a slot length and a symbol length.

In other embodiments, the first resource assignment describes a plurality of retransmission resources in a first period interval, and the time domain position of each of the retransmission resources is determined by a start and length indicator value (SLIV) of a first retransmission resource of the retransmission resources and a number of repetitions of the retransmission resources.

In an embodiment, the storage 13 further stores a mapping table, and the mapping table describes that the start and length indicator value (SLIV) and the number of repetitions are mapped to an index.

In one embodiment, the first resource configuration further comprises traffic type information. In an embodiment, the traffic type information comprises a priority level.

In other embodiments, the resource configuration setting information further comprises at least one logical channel identifier corresponding to the first resource configuration, and each of the at least one logical channel identifier corresponds to a priority level that is associated with a traffic type. In addition, in other embodiments, the resource configuration setting information further comprises a bandwidth part (BWP) identifier corresponding to the first resource configuration.

In other embodiments, the processor 15 further receives a user equipment capability report message from the user equipment via the transceiver 11, and generates resource configuration setting information according to the user equipment capability report message and the periodic traffic pattern information.

Corresponding to the second embodiment, the processor 15 further transmits second downlink control information to the user equipment via the transceiver 11, and the second downlink control information indicates a release of a part or all of the at least one of the activated resource configurations.

Corresponding to the second embodiment, each resource configuration may have an identifier, and the processor 15 further transmits a configuration correspondence message to the user equipment via the transceiver 11. The configuration correspondence message describes a first correspondence relationship between a bit state of the first downlink control information and the resource configurations, and a second correspondence relationship between a bit state of the second downlink control information and the resource configurations.

Corresponding to the third embodiment, a second resource configuration of the resource configurations comprises a second period offset, a second period length and a second resource assignment. In an embodiment, the processor 15 further transmits a configuration switch setting message to the user equipment via the transceiver 11 so that the user equipment alternately uses the first resource configuration and the second resource configuration according to the configuration switch setting message.

In an embodiment, the first resource configuration is used for periodic downlink transmission and has a first identifier, the second resource configuration is used for periodic uplink transmission and has a second identifier, and the first identifier is associated with the second identifier for simultaneously activating or releasing the first resource configuration and the second resource configuration.

Corresponding to the fourth embodiment, the resource configuration setting information comprises a group identifier and group information. The group information describes that a part of the resource configurations belongs to a same group, and the resource configurations in the same group have at least one same resource configuration setting value. In other embodiments, the at least one same resource configuration setting value does not comprise a period offset.

In an embodiment, each activated resource configuration comprises a resource assignment. Each resource assignment describes a resource in a period interval, and the resources are at least partially overlapped in a time domain. Each resource configuration comprises traffic type information, and each piece of traffic type information comprises a priority level to make the user equipment select the resource configuration corresponding to a highest priority level in the priority levels for uplink transmission.

According to the above descriptions, the resource configuration mechanism of the present invention enables the base station of the mobile communication system to allocate a plurality of resource configurations to the user equipments of the TSN system according to the periodic traffic pattern information associated with the user equipments for periodic signal transmission or reception by the user equipments. In addition, the resource configuration mechanism of the present invention may also be used for periodic transmission of the URLLC service type and the eMBB service type, and different resource configurations may have different period lengths to meet different periodic traffic patterns.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A base station for a mobile communication system, comprising:
a transceiver;
a storage, being configured to store periodic traffic pattern information associated with a user equipment; and
a processor, being electrically connected to the transceiver and the storage, and being configured to perform the following operations:
generating resource configuration setting information according to the periodic traffic pattern information, the resource configuration setting information comprising a plurality of resource configurations, a first resource configuration of the resource configurations comprising a first period length, a first period offset and a first resource assignment;
transmitting the resource configuration setting information to the user equipment via the transceiver; and
transmitting first downlink control information to the user equipment via the transceiver, the first downlink control information indicating that at least one of the resource configurations is activated.

2. The base station of claim 1, wherein the processor further transmits second downlink control information to the user equipment via the transceiver, and the second downlink control information indicates a release of a part or all of the at least one of the activated resource configurations.

3. The base station of claim 2, wherein each of the resource configurations has an identifier, the processor further transmits a configuration correspondence message to the user equipment via the transceiver, and the configuration correspondence message describes a first correspondence relationship between a bit state of the first downlink control information and the resource configurations, and a second correspondence relationship between a bit state of the second downlink control information and the resource configurations.

4. The base station of claim 1, wherein a second resource configuration of the resource configurations comprises a second period offset, a second period length and a second resource assignment.

5. The base station of claim 4, wherein the processor further transmits a configuration switch setting message to the user equipment via the transceiver so that the user equipment alternately uses the first resource configuration and the second resource configuration according to the configuration switch setting message.

6. The base station of claim 4, wherein the first resource configuration is used for periodic downlink transmission and has a first identifier, the second resource configuration is used for periodic uplink transmission and has a second identifier, and the first identifier is associated with the second identifier for simultaneously activating or releasing the first resource configuration and the second resource configuration.

7. The base station of claim 1, wherein the resource configuration setting information comprises a group identifier and group information, and the group information describes that a part of the resource configurations belongs to a same group, and the resource configurations in the same group have at least one same resource configuration setting value.

8. The base station of claim 7, wherein the at least one same resource configuration setting value does not include a period offset.

9. The base station of claim 1, wherein the first resource assignment describes at least one resource in a first period interval, a frequency position of each of the at least one resource, and a start and length indicator value (SLIV) of each of the at least one resource, and a start value of the start and length indicator value of each of the at least one resource is represented by an offset in a time domain.

10. The base station of claim 9, wherein the offset is with respect to one of a slot boundary and a start symbol boundary of a physical downlink control channel (PDCCH) resource.

11. The base station of claim 1, wherein the first period offset is with respect to one of a time reference point, the time reference point is one of a frame boundary, a slot boundary and a symbol boundary, and a unit of the first period offset is one of a frame length, a slot length and a symbol length.

12. The base station of claim 1, wherein the first resource assignment describes a plurality of retransmission resources in a first period interval, and a time domain position of each of the retransmission resources is determined by a start and length indicator value (SLIV) of a first retransmission resource of the retransmission resources and a number of repetitions of the retransmission resources.

13. The base station of claim 12, wherein the storage further stores a mapping table, and the mapping table describes that the start and length indicator value and the number of repetitions are mapped to an index.

14. The base station of claim 1, wherein the first resource configuration further comprises traffic type information.

15. The base station of claim 14, wherein the traffic type information comprises a priority level.

16. The base station of claim 1, wherein the resource configuration setting information further comprises at least one logical channel identifier corresponding to the first resource configuration, and each of the at least one logical channel identifier corresponds to a priority level associated with a traffic type.

17. The base station of claim 1, wherein the resource configuration setting information further comprises a bandwidth part (BWP) identifier corresponding to the first resource configuration.

18. The base station of claim 1, wherein the processor further receives a user equipment capability report message from the user equipment via the transceiver, and generates the resource configuration setting information according to the user equipment capability report message and the periodic traffic pattern information.

19. The base station of claim 1, wherein each of the resource configurations is used for periodic uplink transmission, periodic downlink transmission, or periodic side link transmission.

20. The base station of claim 1, wherein each of the activated resource configurations comprises a resource assignment, each of the resource assignments describes a resource in a period interval, the resources are at least partially overlapped in a time domain, each of the resource configurations comprises traffic type information, and each of the traffic type information comprises a priority level to make the user equipment select the resource configuration corresponding to a highest priority level in the priority levels for uplink transmission.
